(19) United States
(12) Patent Application Publication
(10) Pub. No.: US 2016/0362904 A1
(43) Pub. Date: Dec. 15, 2016

(54) DOODLE POOL

(71) Applicant: Bestway Inflatables & Material Corp., Shanghai (CN)

(72) Inventors: Feng Liu, Shanghai (CN); Thomas Sollars, Phoenix, AZ (US); Peter A. Sgromo, San Francisco, CA (US)

(21) Appl. No.: 15/094,982

(22) Filed: Apr. 8, 2016

Related U.S. Application Data
(60) Provisional application No. 62/175,124, filed on Jun. 12, 2015.

(51) Int. Cl. E04H 4/14; F21V 9/16; E04H 4/00

(52) U.S. Cl. CPC E04H 4/148; E04H 4/0025; F21V 9/16; E04H 2004/0068

(57) ABSTRACT

An inflatable pool is provided. The pool includes a floor sheet and an inflatable wall coupled to an outer periphery of the floor sheet. The floor sheet and the inflatable wall define a tub for holding water. The pool further includes a panel coupled to the floor sheet. The panel includes light emitting material that is activated when exposed to ultraviolet light. When the panel is exposed to ultraviolet light, luminous or glowing visual images may appear on the surface of the panel to enhance the user's pool experience.

### CROSS-REFERENCE TO RELATED APPLICATIONS

The present application claims benefit of priority with U.S. Provisional Application No. 62/175,124, filed Jun. 12, 2015, which is hereby incorporated in its entirety by reference.

### FIELD OF THE INVENTION

The present disclosure relates to inflatable swimming pools, and more particularly to inflatable pools incorporating media that display luminous visual images in response to ultraviolet (UV) light.

### BACKGROUND

Inflatable swimming pools or wading pools for the backyards have been commercially available for years. Most existing inflatable pools have similar shapes and colors. Some pools may have sidewalls with images, for example, of fish, turtles, sea urchins, or other animals. But the floor panels of most currently available inflatable pools comprise solid colors, for example, either blue or white. As products that are used mostly by children and young people, these pools are unattractive and mundane. Accordingly, a need therefore exists for inflatable pools that not only have more aesthetic appeal, but are also interactive.

### SUMMARY

An interactive inflatable pool is provided. In one example, the pool includes a floor sheet and an inflatable wall coupled to an outer periphery of the floor sheet. The inflatable wall includes an inner sidewall and an outer sidewall. The floor sheet and the inflatable wall define a tub for holding water. The pool further includes a panel coupled to the floor sheet. The panel includes light emitting material that is activated when exposed to ultraviolet light. When the panel is exposed to ultraviolet light, luminous or glowing visual images may appear, for example, temporarily, on the surface of the panel to enhance the user's pool experience.

A method for fabricating a panel for coupling to a floor sheet of a pool is further provided. The method includes impregnating a noctilucent powder into a polyvinyl chloride (PVC) resin or paste polymer comprising PVC particles suspended in a liquid plasticizer. The resin or paste polymer may be heated to form a gel stock. The gel stock may be calendered using a series of heated rollers to form a continuous sheet of desired thickness. The sheet may then be cooled by passing the sheet around one or more water-cooled drums.

It should be noted that the inflatable pool disclosed herein may be an inflatable swimming pool, or may be an inflatable wading pool. In some implementations, the pool described herein may be non-inflatable.

Other systems, methods, features and advantages of the disclosure will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the implementations briefly described above will be rendered by reference to specific implementations thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 illustrates a perspective view of an inflatable pool according to an embodiment of the present invention.

FIG. 2 illustrates a top view of an inflatable pool according to an embodiment of the present invention.

FIG. 3 illustrates a side view of an inflatable pool according to an embodiment of the present invention.

FIG. 4 illustrates a cross-sectional view of an inflatable pool according to an embodiment of the present invention.

FIG. 5 illustrates a top view of a stencil used to produce figures on the surface of a pool panel according to an embodiment of the present invention.

### DETAILED DESCRIPTION

In the following description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

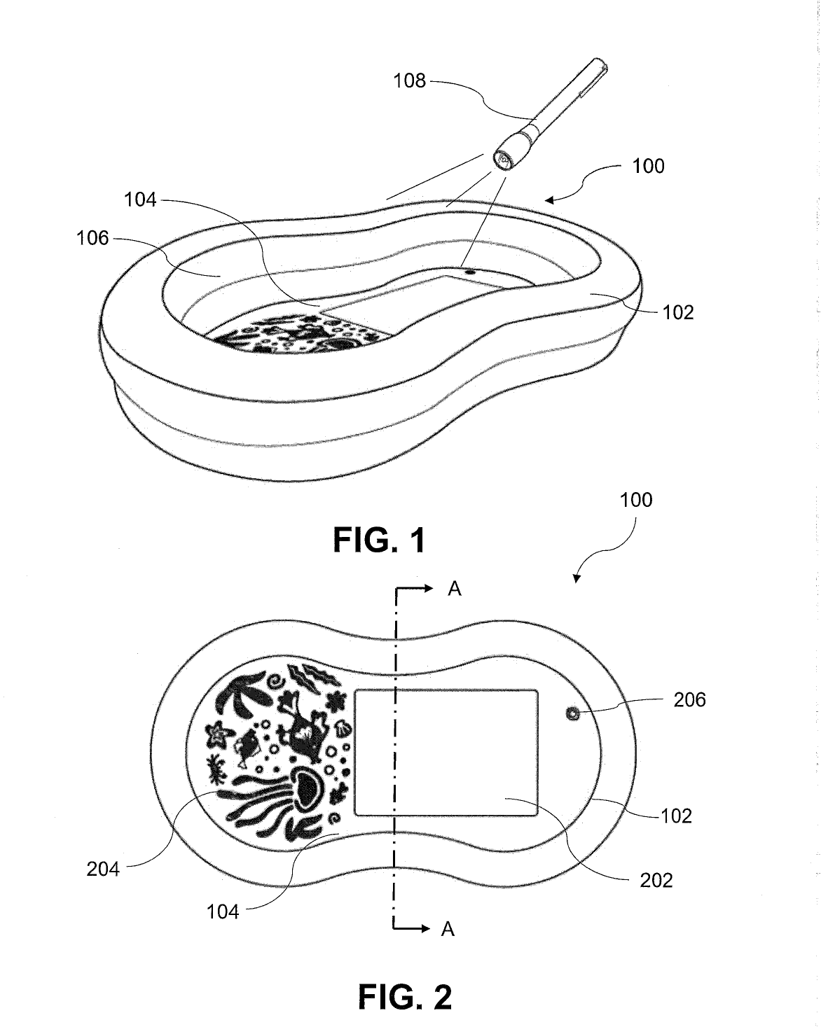

Referring to the drawings, FIGS. 1-5 illustrate examples of different implementations of a pool 100 according to the teachings of the present disclosure. FIG. 1 illustrates a perspective view of the pool 100. In this example, the pool 100 is an inflatable wading pool. As shown, the pool 100 may include an inflatable peripheral wall 102 and a floor sheet 104. The peripheral wall 102 and floor sheet 104 define a tub 106 that may be filled with water. The peripheral wall 102 and the floor sheet 104 may be constructed of transparent or translucent plastic, polyvinyl chloride (PVC), thermoplastic rubber (TPR), polyethylene vinyl acetate (PEVA), ethylene vinyl acetate (EVA), thermoplastic polyurethane elastomer (TPU), neoprene-coated fabric, or any other suitable material. The inflatable pool 100 may be exposed to a light source 108, for example, the sun or any other light source described herein.

FIG. 2 illustrates a top view of the pool 100 according to some implementations. As shown, the peripheral wall 102 may be constructed to an elongated contoured, elliptical shape. Many other shapes are also contemplated including an oval, circular, rectangular, square or various other regular and irregular polygons and shapes. As further shown, the pool 100 further includes a doodle board or panel 202 coupled to the floor sheet 104 of the pool 100. The panel 202 may be constructed of phosphorescence, ultraviolet (UV)-reactive, or other light emitting material to provide the panel 202 with a luminous effect. In the example shown, the light emitting material of the panel 202 emits visible light in response to absorption of electromagnetic radiation (e.g. visible light, ultraviolet light, or infrared light) that has a different wavelength than the emitted visible light. In other implementations, the luminous effect can occur as a result of exposure to visible light or may give off light in a dark environment that has been absorbed from the sun or another light source. In all implementations described herein, the panel 202 may be fixedly coupled with the floor sheet 104, for example, by welding, or the panel 202 may be removably coupled to the floor sheet 104, for example, with suction cups or other suitable means.

In some implementations, the panel 202 may include a sheet of polyvinyl chloride (PVC) impregnated with a phosphorescent material, for example, a noctilucent or fluorescent powder.

In some implementations, the panel 202 may include a sheet or film of material formed by mixing noctilucent powder with a PVC blended powder. In these implementations, the panel 202 may be constructed by impregnating noctilucent powder into a PVC resin or paste polymer comprising PVC particles suspended in a liquid plasticizer. The suspended PVC resin, or plastisol, is then heat treated, which caused the plastisol to gel. The heated gel stock may then be calendered, or hot pressed, using a series of heated rollers to form a continuous sheet of desired thickness, which is subsequently cooled. Final cooling may be achieved by passing the sheet around a number of water-cooled drums which are controlled at decreasing temperatures.

In some implementations, the panel 202 may include a substrate, for example, a layer of white PVC film, overlaid with a fluorescent material that is applied over the substrate, for example, an ink coating including noctilucent or fluorescent powder. To protect the fluorescent material from abrasion due to touch during use, a transparent layer, such as a resin, may be applied as a coating over the fluorescent material.

In other implementations, the panel 202 may include a substrate and a plastic film applied onto the substrate. The substrate may include a layer of white PVC film. The plastic film may include a PVC paste resin and plasticizer mixed and baked with a noctilucent powder. In some examples, the plastic film may have a weight of 2 to 3 si (a unit of weight equal about 0.0005 grams).

As described herein, the pool 100 may have an elongated contoured, elliptical shape. Many other shapes are also contemplated including an oval, circular, rectangular, square or various other regular and irregular polygons and shapes. In some implementations, the panel 202 may also have a shape that corresponds to the shape of the pool 100. In some implementations, the panel 202 may have a shape that is independent of the shape of the pool 100, for example, a rectangular shape having dimensions of, for example, approximately 1000 millimeters by approximately 680 millimeters.

In some implementations, the panel 202 may produce “glowing” graphical images, by the use of fluorescent materials to emit light under optical excitation to produce images, by absorbing excitation UV light and emitting colored light in the visible light spectrum. In these examples, the light emitting material of the panel 202 may permit “glowing” or illuminated figures and characters to be displayed on the surface of the panel 202.

In some implementations, the floor sheet 104 may include one or more fixedly coupled fluorescent color graphic images 204. In other implementations, the graphic images 204 may be removably coupled to the floor sheet 104. In some implementations, the floor sheet 104 may comprise an upper surface of an air-inflatable bottom chamber of the pool.

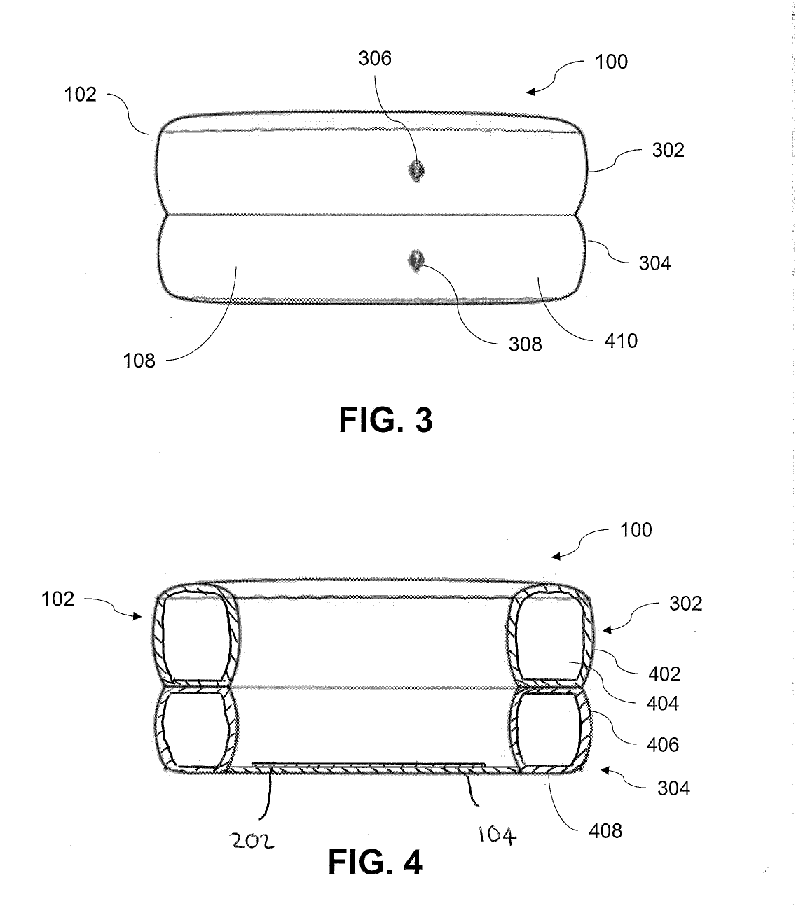

FIG. 3 illustrates a side view of the pool 100 according to some implementations. In these implementations, the peripheral wall 102 may include an inflatable top ring 302 and an inflatable bottom ring 304. An air valve 306 may be positioned in an outer surface or wall of the top ring 302 for inflation and deflation of the top ring 302. An air valve 308 may be positioned in an outer surface or wall of the bottom ring 304 for inflation and deflation of the bottom ring 304.

FIG. 4 illustrates a cross-sectional view along line A-A of FIG. 2. In some implementations, the top ring 302 includes an outer wall 402 having a substantially rectangular shape (in an inflated state) that defines an inflatable upper air chamber 404. An air valve 306 (FIG. 3) may be coupled to the outer wall 402 of the top ring 302. The air valve 306 is in fluid communication with the upper air chamber 404 and allows for inflation of the chamber 404 when the pool 100 is in use, and deflation of the chamber 404 for storage.

The bottom ring 304 includes an outer wall 406 sealingly attached at its upper edge to a bottom edge of the top ring 302 outer wall 402. The upper edge of outer wall 406 may be coupled to the bottom edge of outer wall 402 by suitable coupling techniques, such as radio-frequency (RF) welding, hot-air coupling (e.g., melting or welding), adhering (e.g., gluing) or other means known in the art.

The outer wall 406 of the bottom ring 304 is constructed to a substantially rectangular shape (in an inflated state) that defines an inflatable lower air chamber 408. An air valve 308 (FIG. 3) may be coupled to the outer wall 406 of the bottom ring 304. The air valve 308 is in fluid communication with the lower air chamber 408 and allows for inflation of the chamber 408 when the pool 100 is in use, and deflation of the chamber 408 for storage. It should be noted that although two rings are illustrated, additional or fewer rings or chambers may be included in various implementations.

Referring back to FIGS. 1 and 2, the floor sheet 104 may include a sheet of material (e.g., of plastic) having a perimeter of substantially the same shape and dimensions as the inner contour of the peripheral wall 102. The floor sheet 104 may be attached to the peripheral wall 102 by welding, sealing, or thermal coupling the floor sheet's 104 outer edge or an area on an upper surface of the floor sheet 104 to the bottom edge of the bottom ring 304. As described herein, the floor sheet 104 may include a drain valve 206 (FIG. 2) for releasing water from the pool 100.

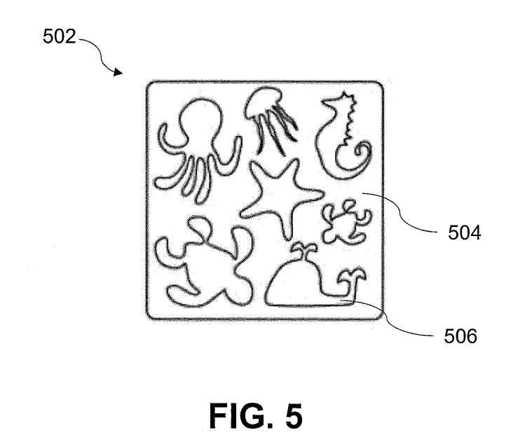

FIG. 5 illustrates, according to some implementations, a top view of a stencil 502 used to produce figures on the surface of the panel 202. The stencil 502 may include a sheet of opaque material 504 having one or more cut-out-images 506 formed therein. The stencil 502 may be removably placed atop the panel 202, for example, as illustrated in FIG. 1. The stencil 502 may receive a light source 108 emitting UV light onto the stencil 502. The UV light emitted from the light source 108 is generally absorbed by the opaque material 502. However, a portion of the UV light may be exposed through the stencil cut-outs 506. The exposed portion of UV light may be absorbed by the light emitting material of the panel 202. When the light emitting material receives the UV light, it may emit visible light. As a result, illuminated (or glowing) images, for example in the form of the cut-out images 506, may be visible on the surface of the panel 202. These images may be illuminated for a period of time, for example 20 to 40 seconds, before they dissipate or otherwise disappear. The illuminated images provide entertainment and enhance the user's experience in the pool 100.

In some implementations, users may generate images by selectively illuminating the panel 202 with UV light, for example, by applying UV light directly onto the panel 202 without a stencil 502 to draw letters, characters, or images on the panel 202.

In some implementations, the light source 108 may include a device having a waterproof or water resistant casing enclosing a power source such as a battery coupled to at least one light emitting diode that emits UV light through a clear lens of the waterproof casing. The device may also include a button or switch which allows a user to turn the at least one light emitting diode on or off.

When the light emitting material of the panel 202 emits visible light in response to the UV light, a down-conversion physical phenomenon occurs. Specifically, UV light has a shorter wavelength and higher energy than visible light. As a result, when the light emitting material of the panel 202 absorbs the UV light and emits lower energy visible light, the UV light is down-converted to visible light because the UV light's energy level goes down when it is converted into visible light.

In other implementations, the light source 108 may include a device having multiple light-emitting diodes (LEDs) emitting different wavelengths of UV light. As such, they can cause different down-conversion effects and different visible colors can appear on the panel 202. At least one switch or button may be provided to enable different settings by providing power to specific LEDs while withholding power to others.

In still other implementations, the device of the light source 108 may also have a directional feature, such as an open-ended cylindrical cover, for directing light in a specific location. This can provide users with greater control over the size of the area they wish to illuminate. In some implementations, the LEDs may have luminous intensity rating of at least 5000 mcd to 8000 mcd.

It should be noted that, in some implementations, the peripheral wall 102 of the pool 100 may be non-inflatable.

In the foregoing specification, the invention has been described with reference to specific implementations thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. For example, this invention is particularly suited for inflatable swimming pools; however, the invention can be used for any pool in general. Additionally and obviously, features may be added or subtracted as desired. Accordingly, the invention is not to be restricted except in light of the attached claims and their equivalents.

What is claimed is:

1. A pool comprising:
a floor sheet;
an inflatable wall coupled to an outer periphery of the floor sheet, the inflatable wall having an inner sidewall and an outer sidewall, the floor sheet and the inflatable wall defining a tub for holding water; and
a panel coupled to the floor sheet, the panel comprising light emitting material that activates by exposure to ultraviolet light.

2. The pool of claim 1, wherein the panel is removably coupled to the floor sheet.

3. The pool of claim 1, wherein the panel is fixed to the floor sheet.

4. The pool of claim 1, wherein the panel is fabricated with phosphorescence, ultraviolet-reactive material.

5. The pool of claim 1, wherein the panel includes a sheet of polyvinyl chloride (PVC) impregnated with a phosphorescent material.

6. The pool of claim 1, wherein the panel includes a sheet or film of material formed by mixing noctilucent powder with a polyvinyl chloride (PVC) blended powder.

7. The pool of claim 1, wherein the panel includes a substrate overlaid with a fluorescent material.

8. The pool of claim 7, wherein the fluorescent material comprises an ink coating comprising noctilucent or fluorescent powder.

9. The pool of claim 7, wherein a transparent layer is applied as a coating over the fluorescent material.

10. The pool of claim 1, wherein the panel includes a substrate and a plastic film applied onto the substrate.

11. The pool of claim 10, wherein the substrate includes a layer of white polyvinyl chloride (PVC) film.

12. The pool of claim 10, wherein the plastic film includes a polyvinyl chloride (PVC) paste resin and plasticizer mixed and baked with a noctilucent powder.

13. The pool of claim 1, wherein the floor sheet further comprises one or more fluorescent color graphic images.

14. The pool of claim 1 further comprising a stencil removably coupled to the panel.

15. The pool of claim 1 further comprising a light source for activating the panel.

16. A method of fabricating a panel for coupling to a floor sheet of a pool, the method comprising:
impregnating noctilucent powder into a polyvinyl chloride (PVC) resin or paste polymer comprising PVC particles suspended in a liquid plasticizer;
heating the resin or paste polymer, forming a gel stock;
calendering the gel stock using a series of heated rollers, forming a sheet of desired thickness; and
cooling the sheet using one or more water-cooled drums.

17. A pool comprising:
a floor sheet including one or more fluorescent color graphic images;
an inflatable wall coupled to an outer periphery of the floor sheet, the inflatable wall having an inner sidewall and an outer sidewall, the floor sheet and the inflatable wall defining a tub for holding water; and
a rectangular-shaped panel fixedly coupled to the floor sheet, the panel comprising light emitting material that activates by exposure to ultraviolet light.

18. The pool of claim 17 further comprising a stencil removably coupled to the panel.

19. The pool of claim 17, wherein the panel is fabricated with phosphorescence, ultraviolet-reactive material.

20. The pool of claim 17, wherein the panel includes a sheet of polyvinyl chloride (PVC) impregnated with a phosphorescent material.
